(19) United States
(12) Patent Application Publication
(10) Pub. No.: US 2008/0098005 A1
(43) Pub. Date: Apr. 24, 2008

(54) INTERACTIVE COMMUNITY PORTAL THAT, INTER ALIA, ALLOWS MEMBERS TO CREATE, MODIFY, ORGANIZE, SHARE, AND RECEIVE WELL-CLASSIFIED CONTENT IN ANY LANGUAGE IN ONE OR MORE FORMATS OF DATABASE FILES AND THE LIKE, AND FURTHER HELPS MEMBERS TO LEARN/TEACH AND/OR ENJOY FROM THE SAID CONTENT

(76) Inventor: Gautam Dharamdas Goradia, Mumbai (IN)

Correspondence Address: INTELLECTUAL PROPERTY LAW GROUP LLP, 12 SOUTH FIRST STREET, SUITE 1205, SAN JOSE, CA, 95113, US

(21) Appl. No.: 11/871,749

(22) Filed: Oct. 12, 2007

(30) Foreign Application Priority Data
Oct. 19, 2006 (IN) 1738/MUM/2006
Nov. 27, 2006 (IN) 1947/MUM/2006
Mar. 9, 2007 (IN) 461/MUM/2007

(51) Int. Cl. G06F 17/30

(52) U.S. Cl. 707/10; 707/E17.001

(57) ABSTRACT

An interactive community portal comprising of one or more communities, which, inter alia allows members to create, modify, organize, share, receive, well-classified content of a diverse nature such as questions and answers, resources for language learning (using vocabulary as a basis), documents, presentations, spreadsheets, or any other file types, URLs (Uniform Resource Locators), literary works, proverbs, sayings, facts and feats, jokes and/or other forms of humor, songs and their lyrics, pictures (such as photographs, drawings, art, sketch, iconography, Illustrations, portraits, paintings, Images and such others), and videos, in a format including but not limited to database files, and further allows such members to network amongst themselves, and offers such utilities that would help the members to learn/teach and/or enjoy from the said content shared by the members.

### CROSS-REFERENCE TO RELATED APPLICATIONS

This application claims priority to India application no. 1738/MUM/2006 filed Oct. 19, 2006; India application no. 1947/MUM/2006 filed Nov. 27, 2006; and India application no. 461/MUM/2007 filed Mar. 9, 2007; all of which are hereby incorporated by reference for all purposes.

### FIELD OF THE INVENTION

The present invention relates to Web 2.0. which refers to the second-generation of the Internet comprising of web-based communities and hosted services—such as social-networking sites, wikis and folksonomies—that aim to facilitate collaboration and sharing between users. In particular, the present invention focuses on the use of an interactive community portal to share, receive and learn well-classified information of a diverse nature.

### BACKGROUND OF THE INVENTION

It is a well-accepted fact that nowadays, people are using the medium of online social networking to, inter alia, collaborate among themselves for business, academic, or personal interests. This fact has its basis in the increasing number of social networking websites, community websites, blogs, forums, folksonomies, wikis, and the like. This phenomenon has been termed as Web 2.0°—the second generation of the Internet where the emphasis has been laid on collaboration and sharing of information between users.

Further, it is also accepted that online social networking has brought people from all over the world on a common platform where they can share their thoughts, ideas, expertise, and do much more. This powerful medium of online social networking has found applications in diverse aspects of life such as education, entertainment, business, matrimony and relationships, and so on.

More so, the application of social networking in education and entertainment has opened up new avenues for these sectors. In the context of education, many websites, portals, applications, wikis, blogs, and other services have come up, which allow people to collaborate and share information on topics of academic interests. To cite a few examples, a teacher can make use of a social networking website or to share knowledge with the students as well as keep track of their progress, a subject Matter Expert can set up his own website/blog or wiki to share his expertise with the rest of the world and so on. These offerings have been grouped under various terms like ‘Education 2.0’, ‘Learning 2.0’, or ‘e-Learning 2.0’.

Further, in the above context, it is imperative to make a mention about self study. While its importance cannot be ruled out, it is also necessary to consider the benefits of testing/evaluating oneself frequently while studying. Scientific research has proven that repeated testing/evaluating helps one to learn much more in less time, than one might by simply studying over and over again. It also aids in better retention. It would thus help if there are specialised software tools available, whether offline or online, that would allow people to self study by giving them the opportunity to test/evaluate themselves from time to time.

Further, it is a well-known fact that nowadays the concept of involving the learner/pupil in the process of creating educational/instructional content is gaining ground the world over. In most of the educational institutions like schools, colleges, and universities, students/pupils create on their own, inter alia, study aids such as flash cards and the like. It should be noted here that students/pupils whether studying at home or in their respective educational institutions, have limited access to resources and/or tools that will enable them to create study aids and other such instructional/educational content. It would thus be of immense help to such students if there are specialised tools/services available for this purpose.

Further, it should be noted that each individual is unique in his/her own way and studies/learns by his/her own pace and grasping ability. Those who have good grasping abilities, take less time to study compared to others. Also, it has been observed that conventional teaching/instructional methods follow the “one size fits all” approach meaning that all students/pupils, irrespective of their grasping abilities, are subjected to the same kind of teaching/instruction. It would therefore help, if there are means available, which will cater to each individual's learning sensibilities.

Further, it would not be out of place here to put forth an argument about the benefits of studying by collaboration. While self study is important in itself, studying in a group (especially in a peer group) has its own advantages. Students/pupils who are good in a particular subject/topic can help others in their group who find it difficult to grasp the same and vice versa. Thus, this kind of mutual collaboration will benefit each member of the group thereby helping them in their respective vocations. It would be great if there was a means to allow such group members to interact with each other, irrespective of their geographical locations.

The philosophy of social networking can be further extended the entertainment sector. Here, people can share videos, photos, jokes, music, and other stuff, on such social networking websites, portals, applications, wikis, blogs, and other services with the rest of the world.

Further, It can be inferred from the above arguments that the concept of ‘User-Generated Content’ (UGC) or content created and shared by users of such websites and services, is gaining acceptance from all quarters. Thus, people nowadays are no longer restricted to subscribing content from a select group of third-party content providers, and share content through mediums such as wikis, blogs, podcasts, and the like.

While it is accepted that the above mentioned services play a pivotal role in sharing and disseminating information, one cannot overlook the importance of sharing and receiving ‘structured’ information. Currently, it has been observed that most of these social networking websites, portals, applications, wikis, blogs, and other services allow users to share content and/or information in a ‘raw’ unstructured format. Further, it has also been observed that these services do not cater to content of a diverse nature such as questions and answers, resources for language learning (using vocabulary as a basis), proverbs, quotes, facts, feats, sayings, literary works and so on.

Further, it is a well accepted fact that database applications can share information between themselves by exchanging database files. A database is a ‘structured’ collection of related information, and each database file is a subset of this collection. Thus, a database file generated from the database of one application can be exported so that it appends the database of another application. This same philosophy can be used to good effect while sharing and receiving information from social networking websites, portals, applications, wikis, blogs, and other services, thereby providing the recipient of such information the dual benefit of receiving information in an organized and structured format, as well as that of appending the recipient's database automatically, which would save the recipient from a lot of effort in re-organizing such received information.

Further, it has been observed that most of the portals, applications, wikis, blogs, and other services provide vast ‘chunks’ of data. Some users who require only a certain part of this data, need to filter the same according to their needs. Most of the times, it has been observed that this activity is a cumbersome process for the users.

Further, it has been observed that most of the portals, applications, wikis, blogs, and other services offer limited or no utilities that will help users to evaluate themselves over a particular subject, create Study Aids like flash cards and snap cards, plan their studies, and do much more.

Further, there is also the need for specialised software tools and/or utilities that would allow users to classify and organize information that is received from such social networking websites, portals, applications, wikis, blogs, and other services.

The prior arts described in the foregoing descriptions have an inherent limitation, in that they do not allow the user to create, modify, organize, share, teach and/or learn from well-classified content of a diverse nature in any language by uploading or downloading the same in a format including but not limited to that of database files.

Therefore, by dint of determined research and intuitive knowledge, our inventor has developed an interactive community portal that, inter alia, allows members to create, modify, organize, share, and receive well-classified content of a diverse nature in any language in a format including but not limited to that of database files, teach and learn from and/or enjoy the said content, evaluate themselves over the said content, create Study Aids like flash cards and snap cards, plan their studies, and do much more.

### US2005159970—Methods and Systems for the Display and Navigation of a Social Network

Systems and methods for the display and navigation of a social network or set forth. According to one embodiment a method comprising identifying a first profile in a social network, identifying associated profiles associated with the first profile, ranking the associated profiles, wherein ranking is not based exclusively on a degree of separation, and outputting the associated profiles based at least in part on the ranking is set forth. According to another embodiment a method comprising identifying a user profile, identifying a member profile, determining an association path for the user profile and the member profile, and outputting the association path is set forth.

### US2006089913—A Method and Apparatus for Optimizing Networking Potential Using a Secured System for an Online Community

The present invention provides a method and apparatus for users to search networks, both their own network and their peers' networks, all under the umbrella of a “multiple level access” security system. The present invention has been designed to optimize networking capabilities among users in a comprehensive online community. Networking among such a secured environment will allow users an opportunity to enhance their networking potential by expanding their networks to their peers' and beyond. A user registers with the online community and personally ads individuals that they know to their personal networking database. While adding these peers to the networking database, the user grants a specific level of access to each individual. This security measure is devised to discourage solicitation from other unwanted online users. The levels of access give the user an opportunity to control the amount of personal information, including contacts that they make, available to their individual peers. Based on the level of access granted by the user, the peer may or may not be able to access the user's personal databases for potential networking. The level of access granted by two individuals need not be the same for each other.

### US2005159998—Methods and Systems Rating Associated Members in a Social Network

Systems and methods for rating associated members in a social network are set forth. According to one embodiment a method comprising outputting a ratings interface for rating at least one member of a social network associated with a user, wherein the rating interface provides the user with the ability to rate the member in one or more categories, receiving ratings for the member from the user, associating the ratings with the member, and connecting the ratings for the member with the user is set forth.

### SUMMARY OF THE INVENTION

The present invention is an interactive community portal comprising of one or more communities, which, inter alia, allows members to login to the same for enjoying the various benefits and utilities available from time to time. It also allows people to register as new members for a fee or otherwise.

Once a member has logged in to the community portal, he/she can perform one or more activities including but not limited to adding/modifying his profile information, inviting other people to register as members of the community portal, send/receive requests to the members in his/her communities, manage members in his/her networks and groups, make notes about daily activities, track the members who have visited his/her profile, chat with other logged-in members, create, organise, share and receive well-classified and organized content of a diverse nature, including but not limited to questions and answers, resources for language learning (using vocabulary as a basis), documents, presentations, spreadsheets, or any other file types, URLs (Uniform Resource Locators), literary works, proverbs, sayings, facts and feats, jokes and/or other forms of humor, Musical Compositions, their Text, lyrics and other related information, and pictures (such as photographs, drawings, art, sketch, iconography, Illustrations, portraits, paintings, Images and such others), videos, moderate content, hire/sell services/content, advertise products/services, comment on other members, report error/abuse, ask/answer questions to or by other members, plan studies, download software and other files/utilities, register as an institution/organization, classify content using curriculum as a basis, teach and/or learn from other members, as well as convert content into an interoperable format such as SCORM (Sharable Content Object Reference Model).

### DETAILED DESCRIPTION OF SPECIFIC EMBODIMENTS OF THE INVENTION

A detailed description of the preferred embodiments and best modes for practicing the present invention are described herein.

An interactive community portal comprising of one or more communities which, inter alia allows logged-in members to create, modify, organize, share, and receive well-classified content of a diverse nature in a format including but not limited to that of database files, and further allows such members to network amongst themselves, and offers such utilities that would help the members to learn/teach and/or enjoy from the said content shared by the members, and to benefit from the various other utilities and features available on the portal from time to time.

The portal consists of a User Interface that renders the user's actions, and with the help of the Control System transmits the appropriate requests to the Databases. The Control System acts as the bridge between the User Interface and the Databases. The Databases consists of the Content Database, Translation Database, User Database and the Configuration Database. Content Database is the reservoir of an extensible collection of well-classified data and further stores the data user wise. The Translation Database is the reservoir of the translated data. The User Database is the reservoir of the user information and also contains the history of past user interaction with the System. The Configuration Database is the reservoir of the options used for the Customization of the portal.

The aforementioned community portal may encompass one or more websites, one or more networks, one or more blogs/forums, one or more intranets, and such present or future technologies that are available, or may be available at any time in the future, which facilitate communication including sharing (herein after referred to as the said portal).

The User Interface of the said portal comprises of the following elements:

### 1. Login and Registration

The said portal allows a member to login with a unique Member ID and Password, for a fee or otherwise, in order to add, upload and/or download content and/or to enjoy the other benefits and the utilities and features that may be available on the said portal from time to time. Further, a person is also allowed to become a new member of the said portal by allowing him/her to register on the same. During registration, a person has to furnish the necessary details as may be required by the said portal from time to time. In case, the person is a minor or underage, on his/her behalf, any other person including but not limited to his/her parent/guardian can register on the said portal. Also, once the same person has become a major, the said portal offers a provision to upgrade his membership accordingly. This upgradation can be done automatically or manually.

### 2. Member Profile Page

Once a member has logged on to the said portal, he/she will be redirected to his/her respective Member Profile Page. The said portal further allots each logged-in member a certain amount of space as may be determined by the terms and policies of the said portal from time to time.
The logged-in member can utilize this space to do a multitude of activities including but not limited to the following:
i) Edit Profile:
   A logged-in member can add or modify personal information about himself/herself including but not limited to his/her profile, photos, interests, groups, and such others. The said portal further allows a logged-in member to restrict the access in part or in whole of his/her personal information, to one or more logged-in members.
ii) Invite:
   A logged-in member can invite people to register as logged-in members of the said portal, in order to access all the utilities and features of the same. Such invites can be sent through the said portal by various means including but not limited to e-mail, SMS (Short Message Service)/MMS (Multimedia Message Service), and Instant Messaging.
iii) Manacle Community Requests:
   A logged-in member can manage the requests that have been sent or received to or by other logged-in members of the said portal. Further, a logged-in member also has the provision to accept, deny, or block requests from one or more logged-in members. A request can be of any kind, for example, a logged-in member can request another logged-in member to share more details about himself/herself.
iv) Manage Members in Network:
   A logged-in member can view the details of other members who have joined his/her network. Here, a logged-in member can mark one or more members as his ‘favourite’. A logged-in member can also specifically search for the details of one or more members on his/her network. A logged-in member can allow any member to contact him/her directly through one or more modes of communication, or to contact him/her only through recommendations sent by members of his existing network. A logged-in member can also block, and/or delete one or more members in his network.
v) Manage Groups:
   A logged-in member can create and/or join one or more Groups based on common interests, hobbies, and such others on the said portal. He/she can further accept requests from one or more members to let them join his/her Group as well as send requests to other members who are Group owners, if he/she wishes to join their Groups.
   Once a member has joined a Group, he/she can view all the information posted by members of the Group, along with their details. A member can also select to receive the information posted in the group through any mode of communication including but not limited to e-mail. A member can leave or be removed one or more Groups at any time. After this, all the information posted by such members will be removed from the Group. Further, a member who is a Group owner is also allowed to permanently delete a Group from the said portal.
vi) Manage Notes:
   A logged-in member can create notes of information including but not limited to day-to-day tasks and activities, and use the same as reminders. A member can choose to receive such reminders through modes of communication including but not limited to e-mail, and/or as alerts on the said portal when he/she logs in. A logged-in member can also delete one or more of his/her notes.
vii) Send and Receive Messages:
   A logged-in member can send and receive messages to other members of the said portal. The messages received from other members will be stored in the current member's inbox, from where he/she can view them at any time. A logged-in member can also delete all the messages that he has sent and/or received.
viii) Track Visits:
   A logged-in member can obtain a report that will display the number of visits made to his/her Member Profile Page by other members of the said portal. The report allows a logged-in member to track the visits made in a day, week, month, or even in a year. A logged-in member also has the option to delete the contents of this report.
ix) Chat with other logged-in members:
   A logged-in member can chat with other members of the said portal who are currently logged-in, as well as access one or more related features.
x) Create, Organise, Share, and Receive content:
   A logged-in member can upload, download, create, organise, share and receive well-classified and organized content of a diverse nature including but not limited to the following areas:
   a) Questions and Answers:
      A logged-in member can build one or more questions and their answers, through the respective interface provided on the said portal. He/she can further classify the same by providing appropriate classifications like source of information, age group, difficulty level, subject and sub subjects. The logged-in member can also convert the question in one or more formats including but not limited to question answer, multiple choice, true/false, fill in the blanks, match maker, and frame a question.
      Further, a logged-in member can also provide additional information for one or more questions, in the form of remarks and/or URLs (Uniform Resource Locators), attachment/association of image, sound, or video files and such others.
      A logged-in member can also modify one or more questions and answers along with their classifications and additional information. Once the logged-in member builds one or more questions on the said portal, the same will be displayed on the relevant section of the said portal in a list format. In this list, against each question, an indication will be provided as to which member is the originator of the question.
      Further, a logged-in member can also upload a file containing one or more questions, their answers, and multiple-choice options, such as a Microsoft Excel Worksheet. For the uploaded file to be accepted by the said portal, the logged-in member will need to ensure that the file is properly formatted as per the guidelines provided by the said portal. Once the file is successfully uploaded, the questions in the file will be displayed in a list format at the relevant section of the said portal. In this list, against each question, an indication will be provided as to which member is the originator of the question.
      Further, a logged-in member can also upload a data file containing one or more questions, their answers, and multiple-choice options, that is generated from a program which the member can download from the said portal. This offline program, inter alia, allows one to build, organise, and share one's own databank of questions and answers in a variety of questioning formats, on any subject, in one or more languages on one's computer. A logged-in member can download this program for free or otherwise.
      Further, a logged-in member can even select one or more questions on the said portal and download the same in the form of a database file. This database file can be then be imported into the program, which the logged-in member had downloaded from the said portal. This leads to the database file appending the existing database of the said program. Once the questions from the said portal are thus downloaded into the said program, one can perform various operations on the same including but not limited to modifying, adding more information, taking practice sessions, tests, and/or quizzes, creating study aids like flash cards, snap cards, and the like.
      In case, the questions that are built and/or uploaded on the said portal cannot be classified under any of the existing classifications on the said portal, then the logged-in member has the provision to define new classifications for such questions.
      Further, a logged-in member can even select one or more questions on the said portal and translate the same into one or more languages of his/her choice. For translation, the logged-in member will need to add a new language on the said portal. The logged-in member can carry out all the operations on these translated questions, in the same manner as in case of normal questions.
      Further, a logged-in member can share the questions built and/or uploaded by him/her in one or more formats such as a database file, PDF (Portable Document Format), HTML (Hyper Text Markup Language), XML (eXtensible Markup Language), WML (Wireless Markup Language) files, blog, RSS (Really simple Syndication), Podcast and so on.
      Further, a logged-in member can create tests and/or quizzes in one or more questioning formats including but not limited to multiple choice, true/false, fill in the blanks, match maker, Frame a question, by selecting one or more of the stored questions and answers, these quizzes either being stored on the said portal, or stored in the form of files including but not limited to HTML (Hyper Text Markup Language), XML (eXtensible Markup Language) and WML (Wireless Markup Language) files.
      Further, the member can take the test/quiz himself/herself on the said portal or invite other members to take the test/quiz on the said portal, by one or more means including but not limited to e-mail, RSS, and the like. The test/quiz displays the questions one after the other, and expects the logged-in member to provide the answer as may be the case depending on the type of questioning format. The member is allotted a time period (either set by the member or automatically set by the system) to answer each question in the test/quiz. The member is accordingly informed when he/she answers a question correctly, incorrectly, not attempted at all, or the time period allotted for answering a question in the test/quiz is over. The member's score, based on his/her performance in the test/quiz, is automatically calculated and displayed once the test/quiz is over. The member is also informed about the time he/she took to complete the test/quiz.
      The member is allowed to end the test/quiz as well as validate his/her answers given to the questions at any point of time during the test/quiz.
      Further, once the test/quiz is over, the member may choose to repeat the test/quiz, or take a test/quiz on the questions that were incorrectly answered by the member in the preceding test/quiz, or take a practice session on the questions that appeared in the preceding test/quiz. A practice session displays the questions along with their corresponding answers, in order that the member practices the same so that he/she may be well prepared before taking a test/quiz. Once a practice session is over, the member may either choose to repeat the same or take a test/quiz on the questions that appeared in the practice session.
      Further, the said portal also allows the logged-in member to create and/or generate the said interactive test/quiz wherein once one or more of the recipient members (the ones who are taking the test/quiz) complete the test/quiz, a file is generated, which contains information about whether the recipients have answered the questions in the test/quiz correctly, incorrectly, not attempted at all or the question was not answered within the allotted time. Once this file is generated, the said portal allows the recipient to store the same either on his/her computer system or handheld device, or on the said portal. The recipient can share the same with the member who is the original creator of the test/quiz in one or more ways including but not limited to e-mail, and/or to any other person who may evaluate the performance of the recipients in the said interactive test/quiz. This utility is especially useful in a teacher-student scenario wherein a teacher can create/generate a test/quiz on the said portal and invite his/her students to log in and take this test/quiz. The students taking this test/quiz, on completion of the same, will generate their respective files which highlight their performance in the said test/quiz. The students may then send this file to their teacher for evaluation purposes.
      Further, going by the above premise, the recipient who is taking the test/quiz has the option of sending this test/quiz to one or more persons and/or members of the said portal. In this case, the recipient becomes the originating member and the members who receive the test/quiz will now become the recipient members. Now, if the recipient members answer the test/quiz and/or complete the same, the file that will be generated will now be sent via e-mail or any other medium to the new originating member (this member is the one who was the original recipient of the test/quiz, and did not create the same).
      The logged-in member can also print such quizzes from the said portal. He/she can also view a list of the quizzes he/she has created so far, as well as delete one or more quizzes.
      Further, a logged-in member can take online practice sessions, quizzes, and/or tests by selecting one or more of the questions and answers that are stored in the said portal. Upon taking such practice sessions, quizzes and/or tests, the logged-in member is provided with various options, which enable them, inter alia, to receive their performance report (with or without negative marking), as well as to create study aids like flash cards, snap cards, snap cards reference sheet, and quiz cards using the questions, repeat practice sessions, quizzes and/or tests, take quizzes and/or tests on incorrectly answered questions in the preceding quiz/test as well as convert a practice session to a quiz and/or test or vice versa.
      Further, a logged-in member can select one or more questions uploaded by other members on the said portal, and rate the same according to their quality, usefulness, and/or popularity.
      Further, a logged-in member can also decide to mark one or more questions so as to be accessed only by himself/herself, or the members who are part of his/her group and/or network, or all the members of the said portal.
      Further, a logged-in member can find questions on the said portal by none or one or more find conditions including but not limited to keywords separated by one or more operators and wildcard characters, classifications like the date, question ID, language, source of information, age group, difficulty level, subject, sub subjects, rating, test/quiz title, test/quiz venue, category and sub categories as well as by file attachments, attachment remarks, association remarks, import remarks, or bookmark remarks including, but not limited to, whether or not the record is marked as “set for practice” or “mastered” or either to be accessed only by the member, or the members who are part of his/her group and/or network, or all the members of the said portal, or either, as well as “favourite”. The member can exercise the option of using the above conditions to bring forth or avoid questions by the specified conditions.
      Further, a logged-in member can select one or more questions stored on the said portal and generate study aids like flash cards, snap cards, snap cards reference sheet, as well as quiz cards, question Lists and test papers with or without answers. The logged-in member if he/she so desires may customize the details to printed in the flash cards and the snap cards. Further, snap cards are usually printed as a pair, one is a question card (which displays the question), and the other its corresponding answer card (which displays the answer to the question). Further, a logged-in member can also generate a snap cards reference sheet which comes in handy while one is playing snap cards games. Using the same, one can verify whether he/she has correctly matched a pair of snap cards, at the end of such games.
   b) Resources for Language Learning (using Vocabulary as a basis):
      A logged-in member can build one or more vocabulary items along with the relevant resources for language learning, through the respective interface provided on the said portal. He/she can further classify the same by providing appropriate classifications like date, language, source of information, type of vocabulary, dialect, age group, difficulty level, subject and sub subjects and part of speech. The logged-in member can also add a short and long meaning (brief and detailed meaning) to the vocabulary items, add the details of the origin of the vocabulary items, add multiple usage examples to the vocabulary items, assign quiz options to the vocabulary items for the purpose of evaluation, assign attributes like synonyms, antonyms, homonyms, homophones, homographs, related vocabulary, glossary, and such others.
      The logged-in member can also convert the vocabulary items in one or more game formats including but not limited to acrossword, figure out, fill in the blanks, hangman, match maker, memory challenge, spelling challenge, word cousins, and word juggler.
      Further, a logged-in member can also provide additional information for one or more vocabulary items, in the form of remarks and/or URLs (Uniform Resource Locators), attachment/association of image, sound, or video files and such others.
      A logged-in member can also modify one or more vocabulary items along with their classifications and additional information.
      Once the logged-in member builds one or more vocabulary items on the said portal, the same will be displayed on the relevant section of the said portal in a list format. In this list, against each question, an indication will be provided as to which member is the originator/contributor of the vocabulary item.
      Further, a logged-in member can also upload a file containing one or more vocabulary items, their meanings, and additional information, such as a Microsoft Excel Worksheet. For the uploaded file to be accepted by the said portal, the logged-in member will need to ensure that the file is properly formatted as per the guidelines provided by the said portal. Once the file is successfully uploaded, the vocabulary items in the file will be displayed in a list format at the relevant section of the said portal. In this list, against each question, an indication will be provided as to which member is the originator/contributor of the vocabulary item.
      Further, a logged-in member can also upload a data file containing one or more vocabulary items, their meanings, and additional information, that is generated from a program which the member can download from the said portal. This offline program, inter alia, allows one to build, organise, and share one's own interactive dictionary and/or thesaurus of words, terms, phrases, etc. (vocabulary) as well as other resources required for language learning on one's computer. A logged-in member can download this program from the said portal, for free or otherwise.
      Further, a logged-in member can even select one or more vocabulary items on the said portal and download the same in the form of a database file. This database file can be then be imported into the program which the logged-in member had downloaded from the said portal. This leads to the database file appending the existing database of the said program. Once the vocabulary items from the said portal are thus downloaded into the said program, one can perform various operations on the same including but not limited to modifying, adding more information, taking practice sessions, tests, and/or quizzes, creating study aids like flash cards, snap cards, and the like.
      In case, the vocabulary items that are built and/or uploaded on the said portal cannot be classified under any of the existing classifications on the said portal, then the logged-in member has the provision to define new classifications for such vocabulary items.
      Further, a logged-in member can even select one or more vocabulary items on the said portal and translate the same into one or more languages of his/her choice. For translation, the logged-in member will need to add a new language on the said portal. The logged-in member can carry out all the operations on these translated vocabulary items, in the same manner as in case of normal vocabulary items.
      Further, a logged-in member can share the vocabulary items built and/or uploaded by him/her in one or more formats such as a database file, PDF (Portable Document Format), HTML (Hyper Text Markup Language), XML (eXtensible Markup Language), WML (Wireless Markup Language) files, blog, RSS (Really simple Syndication), Podcast and so on.
      Further, a logged-in member can create quizzes in one or more questioning formats, by selecting one or more of the stored vocabulary items, these quizzes either being stored on the said portal, or stored in the form of files including but not limited to HTML (Hyper Text Markup Language), XML (eXtensible Markup Language) and WML (Wireless Markup Language) files. The logged-in member can also print such quizzes from the said portal. He/she can also view a list of the quizzes he/she has created so far, as well as delete one or more quizzes.
      Further, a logged-in member can take online practice sessions, quizzes, and/or tests by selecting one or more of the vocabulary items that are stored in the said portal. Upon taking such practice sessions, quizzes and/or tests, the logged-in member is provided with various options, which enable them, inter alia, to receive their performance report (with or without negative marking), as well as to create study aids like flash cards, snap cards, snap cards reference sheet, and quiz cards using the vocabulary items, repeat practice sessions, quizzes and/or tests, take quizzes and/or tests on incorrectly answered questions in the preceding quiz/test as well as convert a practice session to a quiz and/or test or vice versa.
      Further, a logged-in member can select one or more vocabulary items on the said portal, and choose to take tests and/or quizzes based on rules of grammar (of any language), including but not limited to the following:
   1. Count
      In this type of test/quiz, the logged-in member is presented with a word, and is required to choose whether the word is a singular, plural, or collective noun. For a example, if the word is “CAT”, then it is a singular noun, if the word “CATS”, then it is a plural noun, and if the word is “MOB”, then it is a collective noun.
   2. Degrees of Comparison
      In this type of test/quiz, the logged-in member is presented with a word or a set of words, and is required to choose whether the word is a positive, comparative, or superlative adjective. For example, if the word is “BASHFUL”, then it is a positive adjective, if it is “MORE BASHFUL”, then it is a comparative adjective, and if it is “MOST BASHFUL”, then it is a superlative adjective.
   3. Gender
      In this type of test/quiz, the logged-in member is presented with a word, and is required to choose whether the word belongs to the masculine gender, feminine gender, neuter gender, common gender, or neither gender. For example, if the word is COLT then it is of masculine gender, if the word is FILLY then it is of feminine gender, if the word is CHAIR then it is of neuter gender, if the word is JOEY then it is of common gender, if the word is FOAL then it is of neither gender.
   4. Tense
      In this type of test/quiz, the logged-in member is presented with a sentence, and is required to choose whether the sentence is in the simple present, present continuous, present perfect, present perfect continuous, simple past, past continuous, past perfect, past perfect continuous, simple future, future continuous, future perfect, or in the future perfect continuous tense. For example, the sentence “John and William Play volleyball.” will be in the simple present tense, the sentence “John and William are playing volleyball” will be in the present continuous tense and so on.
   5. Voice
      In this type of test/quiz, the logged-in member is presented with a sentence, and is required to guess whether the sentence is in the active voice or the passive voice. For example, if there is a sentence as “Tim's mother warned him not to jaywalk on his way to school”, it is in the active voice, or if there is a sentence as “Tim was warned by his mother not to jaywalk on his way to school.”, it is in the passive voice.
   6. Parts of Speech
      In this type of test/quiz, the logged-in member is presented with a word and its one or more inflected forms. The logged-in member is required to guess the part of speech to which each of these inflected forms belong. For example, the logged-in member is presented with the word ‘ACQUIESCE’ which is a verb. Further, the inflected forms of this word like ‘ACQUIESCENT’, ‘ACQUIESCENCE’, and ‘ACQUIESCENTLY’ are also presented. Now, the logged-in member can guess the part of speech of these inflected forms as adjective for ‘ACQUIESCENT’, noun for ‘ACQUIESCENCE’, and adverb for ‘ACQUIESCENTLY’ respectively.
      Further, a logged-in member can select one or more vocabulary items uploaded by other members on the said portal and rate the same according to their quality, usefulness, and/or popularity.
      Further, a logged-in member can also decide to mark one or more vocabulary items so as to be accessed only by himself/herself, or the members who are part of his/her group and/or network, or all the members of the said portal.
      Further, a logged-in member can find vocabulary items on the said portal by none or one or more find conditions including but not limited to keywords separated by one or more operators and wildcard characters, classifications like the date, record id, language, source of information, type of vocabulary, dialect, age group, difficulty level, subjects, sub subjects, part of speech, length of vocabulary, plurality of characters with a choice to include or exclude such characters used in a vocabulary item, phonetic search, as well as by attributes like synonyms, antonyms, homonyms, homophones, homographs, related vocabulary, etc., tests/quizzes being found by none or one or more of the classifications under which they were created or modified, rating, test/quiz title, test/quiz venue, category and sub categories as well as by file attachments, attachment remarks, association remarks, import remarks, or bookmark remarks including, but not limited to, whether or not the record is marked as “set for practice” or “mastered” or either, to be accessed only by the member, or the members who are part of his/her group and/or network, or all the members of the said portal, or either, as well as “favourite”. The member can exercise the option of using the above conditions to bring forth or avoid vocabulary items by the specified conditions.
      Further, a logged-in member can select one or more vocabulary items stored on the said portal and generate study aids like flash cards, snap cards, snap cards reference sheet, as well as quiz cards, and test papers with or without answers. The logged-in member, if he/she so desires may customize the details to printed in the flash cards and the snap cards. Further, snap cards are usually printed as a pair, one is a question card (which displays the vocabulary item), and the other its corresponding answer card (which displays details like the meaning of the vocabulary item or its pictorial representation). Further, a logged-in member can also generate a snap cards reference sheet which comes in handy while one is playing snap cards games. Using the same, one can verify whether he/she has correctly matched a pair of snap cards, at the end of such games.
   c) Files and URLs (Uniform Resource Locators):
      A logged-in member can upload one or more records in the form of a database file such as documents, presentations, spreadsheets, or any other file types, URLs (Uniform Resource Locators) through the respective interface provided on the said portal. This database file is generated from a program which the member can download from the said portal. This offline program, inter alia, allows one to build, organise, and share one's own databank of such records in any language on one's computer or handheld device. A logged-in member can download this program from the said portal, for free or otherwise. Once the logged-in member uploads one or more records on the said portal, the same will be displayed on the relevant section of the said portal in a list format. In this list, against each record, an indication will be provided as to which member is the originator/contributor of the same.
      A logged-in member can further classify the same by providing appropriate classifications like date, language, source of information, source of information, index letter, age group, subject, and sub subjects. The logged-in member can also provide additional information about a record including but not limited to remarks, and/or URLs (Uniform Resource Locators), attachment/association of image, sound, or video files and such others.
      A logged-in member can also modify one or more records only with respect to their classifications and additional information.
      Further, a logged-in member can even select one or more records on the said portal and download the same in the form of a database file. This database file can be then be imported into the program which the logged-in member had downloaded from the said portal. This leads to the database file appending the existing database of the said program. Once the records from the said portal are thus downloaded into the said program, one can perform various operations on the same including but not limited to modifying, and/or adding more information.
      In case, the records that are built and/or uploaded on the said portal cannot be classified under any of the existing classifications on the said portal, then the logged-in member has the provision to define new classifications for such records.
      Further, a logged-in member can select one or more records uploaded by other members on the said portal and rate the same according to their quality, usefulness, and/or popularity.
      Further, a logged-in member can link one or more records on the said portal with each other for the purpose of cross-reference.
      Further, a logged-in member can even select one or more records on the said portal and translate the same into one or more languages of his/her choice. For translation, the logged-in member will need to add a new language on the said portal. The logged-in member can carry out all the operations on these translated records, in the same manner as in case of normal records.
      Further, a logged-in member can also decide to mark one or more records so as to be accessed only by himself/herself, or the members who are part of his/her group and/or network, or all the members of the said portal.
      Further, a logged-in member can find records on the said portal by none or one or more find conditions including but not limited to keywords separated by one or more operators and wildcard characters, classifications like date, record id, language, source of information, index letter, age group, subject, and sub subjects, file extension, file attachments, associations, attachment remarks, association remarks, import remarks, or bookmark remarks including, but not limited to, whether or not the record is marked so as to be accessed only by the member, or the members who are part of his/her group and/or network, or all the members of the said portal or either, “favourite”. The member can exercise the option of using the above conditions to bring forth or avoid records by the specified conditions.
   d) Literary Works:
      A logged-in member can build one or more literary works such as novels, short stories, poems, essays, scripts, rhymes, theses, verse, composition, manuscripts, transcripts, articles and such others through the respective interface provided on the said portal. He/she can further classify the same by providing appropriate classifications like date, language, source of information, age group, type of literature, genre and sub genre, author/poet, and publisher. The logged-in member can also provide additional information about a work of literature such as synopsis, background of literature, critical appreciation, book/publication, awards won, main characters, and remarks, and/or URLs (Uniform Resource Locators), attachment/association of image, sound, or video files and such others.
      A logged-in member can also modify one or more literary works along with their classifications and additional information.
      Once the logged-in member builds one or more literary works on the said portal, the same will be displayed on the relevant section of the said portal in a list format. In this list, against each literary work, an indication will be provided as to which member is the originator/contributor of the same.
      Further, a logged-in member can also upload a file containing one or more literary works, such as a Microsoft Excel Worksheet. For the uploaded file to be accepted by the said portal, the logged-in member will need to ensure that the file is properly formatted as per the guidelines provided by the said portal. Once the file is successfully uploaded, the literary works in the file will be displayed in a list format at the relevant section of the said portal. In this list, against each literary work, an indication will be provided as to which member is the originator/contributor of the same.
      Further, a logged-in member can also upload a database file containing one or more literary works, that is generated from a program which the member can download from the said portal. This offline program, inter alia, allows one to build, organise, and share one's own databank of literary works in any language on one's computer or handheld device. A logged-in member can download this program from the said portal, for free or otherwise.
      Further, a logged-in member can even select one or more literary works on the said portal and download the same in the form of a database file. This database file can be then be imported into the program which the logged-in member had downloaded from the said portal. This leads to the database file appending the existing database of the said program. Once the literary works from the said portal are thus downloaded into the said program, one can perform various operations on the same including but not limited to modifying, and/or adding more information.
      In case, the literary works that are built and/or uploaded on the said portal cannot be classified under any of the existing classifications on the said portal, then the logged-in member has the provision to define new classifications for such literary works.
      Further, a logged-in member can even select one or more literary works on the said portal and translate the same into one or more languages of his/her choice. For translation, the logged-in member will need to add a new language on the said portal. The logged-in member can carry out all the operations on these translated literary works, in the same manner as in case of normal literary works.
      Further, a logged-in member can share the literary works built and/or uploaded by him/her in one or more formats such as a database file, PDF (Portable Document Format), HTML (Hyper Text Markup Language), XML (eXtensible Markup Language), WML (Wireless Markup Language) files, blog, RSS (Really simple Syndication), Podcast and so on.
      Further, a logged-in member can select one or more literary works uploaded by other members on the said portal and rate the same according to their quality, usefulness, and/or popularity.
      Further, a logged-in member can also select one or more literary works from the said portal and start a literature session where he/she can view the literary works displayed one after the other at pre-determined time intervals.
      Further, a logged-in member can also decide to mark one or more literary works so as to be accessed only by himself/herself, or the members who are part of his/her group and/or network, or all the members of the said portal.
      Further, a logged-in member can find literary works on the said portal by none or one or more find conditions including but not limited to keywords separated by one or more operators and wildcard characters, classifications like the date, record id, language, source of information, age group, type of literature, genre and sub genre, title, author/poet, main characters, awards won, book/publication, and publisher, as well as by keywords, wildcard characters, file attachments, associations, attachment remarks, association remarks, import remarks, or bookmark remarks including, but not limited to, whether or not the record is marked so as to be accessed only by the member, or the members who are part of his/her group and/or network, or all the members of the said portal, “favourite” as well as assigned a rating, and/or by whether or not a record has been used in a literature session and if so, the number of times it has been used. The member can exercise the option of using the above conditions to bring forth or avoid literary works by the specified conditions.
   e) Wisdom Bytes:
      A logged-in member can build one or more wisdom bytes such as Words of wisdom like adages, aphorisms, apothegms, axioms, catchwords, dictums, epigrams, epithets, expressions, gospels, home truths, idioms, mantras, maxims, mottos, phrases, proverbs, quotations, sayings, slogans and such others, basic truths, and/or facts and feats and such others through the respective interface provided on the said portal. He/she can further classify the same by providing appropriate classifications like date, language, source of information, type of wisdom byte, subject and sub subjects.
      The logged-in member can also provide additional information including but not limited to remarks, and/or URLs (Uniform Resource Locators), attachment/association of image, sound, or video files and such others.
      A logged-in member can also modify one or more wisdom bytes along with their classifications and additional information.
      Once the logged-in member builds one or more wisdom bytes on the said portal, the same will be displayed on the relevant section of the said portal in a list format. In this list, against each wisdom byte, an indication will be provided as to which member is the originator/contributor of the same.
      Further, a logged-in member can also upload a file containing one or more wisdom bytes, such as a Microsoft Excel Worksheet. For the uploaded file to be accepted by the said portal, the logged-in member will need to ensure that the file is properly formatted as per the guidelines provided by the said portal. Once the file is successfully uploaded, the wisdom bytes in the file will be displayed in a list format at the relevant section of the said portal. In this list, against each wisdom byte, an indication will be provided as to which member is the originator/contributor of the same.
      Further, a logged-in member can also upload a database file containing one or more wisdom bytes, that is generated from a program which the member can download from the said portal. This offline program, inter alia, allows one to build, organise, and share one's own databank of wisdom bytes in any language, on one's computer system or handheld device. A logged-in member can download this program from the said portal, for free or otherwise.
      Further, a logged-in member can even select one or more wisdom bytes on the said portal and download the same in the form of a database file. This database file can be then be imported into the program which the logged-in member had downloaded from the said portal. This leads to the database file appending the existing database of the said program. Once the wisdom bytes from the said portal are thus downloaded into the said program, one can perform various operations on the same including but not limited to modifying, and/or adding more information.
      In case, the wisdom bytes that are built and/or uploaded on the said portal cannot be classified under any of the existing classifications on the said portal, then the logged-in member has the provision to define new classifications for such wisdom bytes.
      Further, a logged-in member can share the wisdom bytes built and/or uploaded by him/her in one or more formats such as a database file, PDF (Portable Document Format), HTML (Hyper Text Markup Language), XML (eXtensible Markup Language), WML (Wireless Markup Language) files, blog, RSS (Really simple Syndication), Podcast and so on.
      Further, a logged-in member can select one or more wisdom bytes and rate the same according to their quality, usefulness, and/or popularity.
      Further, a logged-in member can even select one or more wisdom bytes on the said portal and translate the same into one or more languages of his/her choice. For translation, the logged-in member will need to add a new language on the said portal. The logged-in member can carry out all the operations on these translated wisdom bytes, in the same manner as in case of normal wisdom bytes.
      Further, a logged-in member can also select one or more wisdom bytes from the said portal and start a wisdom byte session where he/she can view the wisdom bytes displayed one after the other at pre-determined time intervals.
      Further, a logged-in member can also decide to mark one or more wisdom bytes so as to be accessed only by himself/herself, or the members who are part of his/her group and/or network, or all the members of the said portal.
      Further, a logged-in member can find wisdom bytes on the said portal by none or one or more find conditions including but not limited to keywords separated by one or more operators and wildcard characters, classifications like the date, record id, language, source of information, type of wisdom byte, subject, sub subjects, as well as by keywords, wildcard characters, file attachments, associations, attachment remarks, association remarks, import remarks, or bookmark remarks including, but not limited to, whether or not the record is marked so as to accessed only by the member, or the members who are part of his/her group and/or network, or all the members of the said portal, “favourite” as well as assigned a rating, and/or by whether or not a record has been used in a wisdom byte session and if so, the number of times it has been used. The member can exercise the option of using the above conditions to bring forth or avoid wisdom bytes by the specified conditions.
   f) Jokes and/or other forms of Humor:
      A logged-in member can build one or more jokes and/or other forms of humor through the respective interface provided on the said portal. He/she can further classify the same by providing appropriate classifications like date, language, source of information, age group, type of Joke, subject and sub subjects.
      The logged-in member can also provide additional information including but not limited to remarks, and/or URLs (Uniform Resource Locators), attachment/association of image, sound, or video files and such others. A logged-in member can also modify one or more jokes and/or other forms of humor along with their classifications and additional information.
      Once the logged-in member builds one or more jokes and/or other forms of humor on the said portal, the same will be displayed on the relevant section of the said portal in a list format. In this list, against each joke and/or other form of humor, an indication will be provided as to which member is the originator/contributor of the same.
      Further, a logged-in member can also upload a file containing one or more jokes and/or other forms of humor, such as a Microsoft Excel Worksheet. For the uploaded file to be accepted by the said portal, the logged-in member will need to ensure that the file is properly formatted as per the guidelines provided by the said portal. Once the file is successfully uploaded, the jokes and/or other forms of humor in the file will be displayed in a list format at the relevant section of the said portal. In this list, against each joke and/or other form of humor, an indication will be provided as to which member is the originator/contributor of the same.
      Further, a logged-in member can also upload a database file containing one or more jokes and/or other forms of humor, that is generated from a program which the member can download from the said portal. This offline program, inter alia, allows one to build, organise, and share one's own databank of jokes and/or other forms of humor in any language, on one's computer system or handheld device. A logged-in member can download this program from the said portal, for free or otherwise.
      Further, a logged-in member can even select one or more jokes and/or other forms of humor on the said portal and translate the same into one or more languages of his/her choice. For translation, the logged-in member will need to add a new language on the said portal. The logged-in member can carry out all the operations on these translated jokes and/or other forms of humor, in the same manner as in case of normal jokes and/or other forms of humor.
      Further, a logged-in member can even select one or more jokes and/or such humor on the said portal and download the same in the form of a database file. This database file can be then be imported into the program which the logged-in member had downloaded from the said portal. This leads to the database file appending the existing database of the said program. Once the jokes and/or such humor from the said portal are thus downloaded into the said program, one can perform various operations on the same including but not limited to modifying, and/or adding more information.
      In case, the jokes and/or other forms of humor that are built and/or uploaded on the said portal cannot be classified under any of the existing classifications on the said portal, then the logged-in member has the provision to define new classifications for such jokes and/or other forms of humor.
      Further, a logged-in member can select one or more jokes and/or other forms of humor and rate the same according to their quality, and/or popularity.
      Further, a logged-in member can share the jokes and/or other forms of humor built and/or uploaded by him/her in one or more formats such as a database file, PDF (Portable Document Format), HTML (Hyper Text Markup Language), XML (eXtensible Markup Language), WML (Wireless Markup Language) files, blog, RSS (Really simple Syndication), Podcast and so on.
      Further, a logged-in member can also select one or more jokes and/or other forms of humor from the said portal and start a Laughter session where he/she can view the jokes and/or other forms of humor displayed one after the other at pre-determined time intervals.
      Further, a logged-in member can also decide to mark one or more jokes and/or other forms of humor so as to be accessed only by himself/herself, or the members who are part of his/her group and/or network, or all the members of the said portal.
      Further, a logged-in member can find jokes and/or other forms of humor on the said portal by none or one or more find conditions including but not limited to keywords separated by one or more operators and wildcard characters, classifications like the date, record id, language, source of information, age group, type of Joke, subject, sub subjects, file attachments, associations, attachment remarks, association remarks, import remarks, or bookmark remarks including, but not limited to, whether or not the record is marked so as to be accessed only by the member, or the members who are part of his/her group and/or network, or all the members of the said portal, “favourite” as well as assigned a rating. The member can exercise the option of using the above conditions to bring forth or avoid jokes and/or other forms of humor by the specified conditions.
   g) Songs and Lyrics:
      A logged-in member can build one or more records comprising of the lyrics, text and other related information of musical compositions through the respective interface provided on the said portal. He/she can further classify the same by providing appropriate classifications like date, language, source of information, type of record, age group, language, genre, category, title, first letter/syllable/word, singer(s)/band(s), film/album, lyricist(s), music director(s)/composer(s), year of release, picturised on, scene description, award(s), main instrument(s).
      The logged-in member can also provide additional information including but not limited to remarks, and/or URLs (Uniform Resource Locators), attachment/association of image, sound, or video files and such others.
      A logged-in member can also modify one or more records comprising of the lyrics, text and other related information of musical compositions along with their classifications and additional information.
      Once the logged-in member builds one or more records comprising of the lyrics, text and other related information of musical compositions on the said portal, the same will be displayed on the relevant section of the said portal in a list format. In this list, against each record, an indication will be provided as to which member is the originator/contributor of the same.
      Further, a logged-in member can also upload a file containing one or more records comprising of the lyrics, text and other related information of musical compositions, such as a Microsoft Excel Worksheet. For the uploaded file to be accepted by the said portal, the logged-in member will need to ensure that the file is properly formatted as per the guidelines provided by the said portal. Once the file is successfully uploaded, the records in the file will be displayed in a list format at the relevant section of the said portal. In this list, against each record, an indication will be provided as to which member is the originator/contributor of the same.
      Further, a logged-in member can also upload a database file containing one or more records comprising of the lyrics, text and other related information of musical compositions, that is generated from a program which the member can download from the said portal. This offline program, inter alia, allows one to build, organise, and share one's own databank of records comprising the lyrics, text and other related information of musical compositions in any language, on one's computer system or handheld device. A logged-in member can download this program from the said portal, for free or otherwise.
      Further, a logged-in member can even select one or more records comprising the lyrics, text and other related information of musical compositions on the said portal and download the same in the form of a database file. This database file can be then be imported into the program which the logged-in member had downloaded from the said portal. This leads to the database file appending the existing database of the said program. Once the records comprising the lyrics, text and other related information of musical compositions from the said portal are thus downloaded into the said program, one can perform various operations on the same including but not limited to modifying, and/or adding more information.
      In case, the records comprising the lyrics, text and other related information of musical compositions that are built and/or uploaded on the said portal cannot be classified under any of the existing classifications on the said portal, then the logged-in member has the provision to define new classifications for the same.
      Further, a logged-in member can select one or more records comprising the lyrics, text and other related information of musical compositions and rate the same according to their quality, and/or popularity.
      Further, a logged-in member can even select one or more records comprising the lyrics, text and/or other related information of musical compositions on the said portal and translate the same into one or more languages of his/her choice. For translation, the logged-in member will need to add a new language on the said portal. The logged-in member can carry out all the operations on these translated records, in the same manner as in case of normal records.
      Further, a logged-in member can share the records comprising the lyrics, text and/or other related information of musical compositions built and/or uploaded by him/her in one or more formats such as a database file, PDF (Portable Document Format), HTML (Hyper Text Markup Language), XML (eXtensible Markup Language), WML (Wireless Markup Language) files, blog, RSS (Really simple Syndication), Podcast and so on.
      Further, a logged-in member can also select one or more records comprising the lyrics, text and other related information of musical compositions from the said portal and start a music session where he/she can view the records displayed one after the other at pre-determined time intervals.
      Further, a logged-in member can also decide to mark one or more records comprising of the lyrics, text, and other related information of musical compositions, so as to be accessed only by himself/herself, or the members who are part of his/her group and/or network, or all the members of the said portal.
      Further, a logged-in member can find records comprising the lyrics, text and other related information of musical compositions on the said portal by none or one or more find conditions including but not limited to keywords separated by one or more operators and wildcard characters, classifications like the date, record id, type of record, age group, language, genre, category, title, first letter/syllable/word, singer(s)/band(s), film/album, lyricist(s), music director(s)/composer(s), year of release, picturised on, scene description, award(s), main instrument(s), file attachments, associations, attachment remarks, association remarks, import remarks, or bookmark remarks including, but not limited to, whether or not the record is marked so as to be accessed only by the member, or the members who are part of his/her group and/or network, or all the members of the said portal, “favourite” as well as assigned a rating. The member can exercise the option of using the above conditions to bring forth or avoid records by the specified conditions.
      Further, a logged-in member has the option to synchronize the lyrics with their respective songs in such a manner that when the songs are played on the said portal, the appropriate lyrics will be displayed.
      Further, a logged-in member can play a game of ‘Antakshari’ with one or more logged-in members or groups of logged-in members on the said portal by joining one or more ‘Antakshari zones’ on the said portal. ‘Antakshari’ is a game played by two or more people and is particularly popular as a group activity. The game is generally begun with a player singing a particular song. The last letter of the last word in the song sung by the first player, is used by the next player to sing another song, beginning with that letter. The logged-in members of the said portal have the option of playing ‘Antakshari’ in any format, including but not limited to a voice-based ‘Antakshari’ (by singing online) and a text-based ‘Antakshari’ (by chatting and/or instant messaging). The score for each member is calculated and updated on the said portal, according to his/her performance in the ‘Antakshari’ games played so far. The logged-in members have the option of creating their own rules to play this game. For example, they may play the game by singing songs of particular bands/artists and/or films, or time period and the kind.
   h) Pictures:
      A logged-in member can upload one or more pictures (such as photographs, drawings, art, sketch, iconography, illustrations, portraits, paintings, Images and such others), and such others through the respective interface provided on the said portal. He/she can further classify the same by providing appropriate classifications like date, record id, source of information, type of picture, creator of picture, category and sub category.
      The logged-in member can also provide additional information, including but not limited to additional information about a picture such as camera used, location, name of photographer/artist and remarks, and/or URLs (Uniform Resource Locators), attachment/association of image, sound, or video files and such others. A logged-in member can also modify one or more pictures along with their classifications and additional information.
      Once the logged-in member uploads one or more pictures on the said portal, the same will be displayed on the relevant section of the said portal in a list format. In this list, against each picture, an indication will be provided as to which member is the originator/contributor of the same.
      Further, a logged-in member can also upload a database file containing one or more pictures, that is generated from a program which the member can download from the said portal. This offline program, inter alia, allows one to build, organise, and share one's own databank of pictures, on one's computer system or handheld device. A logged-in member can download this program from the said portal, for free or otherwise.
      Further, a logged-in member can even select one or more pictures on the said portal and download the same in the form of a database file. This database file can be then be imported into the program which the logged-in member had downloaded from the said portal. This leads to the database file appending the existing database of the said program. Once the pictures from the said portal are thus downloaded into the said program, one can perform various operations on the same including but not limited to modifying, and/or adding more information.
      In case, the pictures that are built and/or uploaded on the said portal cannot be classified under any of the existing classifications on the said portal, then the logged-in member has the provision to define new classifications for the same.
      Further, a logged-in member can select one or more pictures uploaded by other members on the said portal and rate the same according to their quality, usefulness, and/or popularity.
      Further, a logged-in member can share the pictures built and/or uploaded by him/her in one or more formats such as a database file, PDF (Portable Document Format), HTML (Hyper Text Markup Language), XML (eXtensible Markup Language), WML (Wireless Markup Language) files, blog, RSS (Really simple Syndication), Podcast and so on.
      Further, a logged-in member can also select one or more pictures from the said portal and start a picture session where he/she can view the pictures displayed one after the other at pre-determined time intervals.
      Further, a logged-in member can also decide to mark one or more pictures so as to be accessed only by himself/herself, or the members who are part of his/her group and/or network, or all the members of the said portal.
      Further, a logged-in member can find pictures on the said portal by none or one or more find conditions including but not limited to keywords separated by one or more operators and wildcard characters, classifications like the date, record id, source of information, type of picture, creator of picture, category and sub category, file attachments, associations, attachment remarks, association remarks, import remarks, or bookmark remarks including, but not limited to, whether or not the picture is marked so as to be accessed only by the member, or the members who are part of his/her group and/or network, or all the members of the said portal, “favourite” as well as assigned a rating, and/or by whether or not a picture has been used in a picture session and if so, the number of times it has been used. The member can exercise the option of using the above conditions to bring forth or avoid pictures by the specified conditions.
xi) Moderate Content
   A logged-in member can volunteer to become a ‘moderator’ on the said portal. A ‘moderator’ is one who moderates the content uploaded in one or more sections of the said portal, as per the policies of the said portal. A ‘moderator’ has the authority to modify and/or to delete the content as per the policies of the said portal. Further, a ‘moderator’ can select the criteria according to which he/she wishes to moderate. For example, a ‘moderator’ can choose to moderate the content classsified under the subject SCIENCE. The said portal will display from time to time, inter alia, statistics such as the list of the content which is pending to be moderated, as well as the number of moderations carried out so far on the said portal. Once a ‘moderator’ has moderated the content, any logged-in member who is not satisfied with the ‘moderator’s work, can start a ‘dispute’ against the ‘moderator’ on the said portal. The final decision in this ‘dispute’ will then be taken by an authority having administrative rights on the said portal, including but not limited to a group/panel of experts.
xii) Hire/Sell Services/Content
   A logged-in member can volunteer to sell his services/content to other logged-in members, on the said portal. For example, if a teacher has registered as a logged-in member, he/she can provide her teaching/mentoring services to other logged-in members who may be students. A teacher can also build and/or upload premium content on the said portal, which he/she can sell to the other logged-in members.
   Further, premium content providers to individual, educational institutions, corporate organizations and the like, can also sell their content through the said portal.
   The said portal will receive a commission from the sales arising from the hiring of services and the selling of content on the said portal, subject to the terms and policies of the said portal.
xiii) Advertise Products/Services
   A logged-in member can choose to advertise his products and/or services in one or more sections of the said portal, for a fee or otherwise, subject to the policies of the said portal. Further, the said portal offers a means to share with the members, the revenue generated through advertising on the said portal, subject to the policies of the said portal.
xiv) Comment
   A logged-in member can leave a comment on one or more member's Profile Page. This comment can be of any nature including but not limited to a friendly gesture, an appreciation, and the like. The community of logged-in members will be responsible for moderating such comments.
xv) Report Error/Abuse
   A logged-in member can report, inter alia, an error or abuse including but not limited to copyright, and trade mark violation, relating to the content uploaded by other logged-in members on the said portal, to the said portal. The said portal on receiving such a report will take the appropriate action subject to the terms and policies of the said portal.
xvi) Ask/answer questions
   A logged-in member can post questions on the relevant section of the said portal in order to get appropriate answers from the other members. In the same manner, a logged-in member can volunteer to answer the questions posted by other members on the said portal. The nature of such questions can be very diverse and will be including but not limited to day-to-day life and activities.
xvii) Plan Studies
   A logged-in member can avail of the Study Planner utility on the said portal in order to plan his/her Studies in an organised manner. A logged-in member can create, modify, as well as remove Study Plans as per his/her choice. This Study Planner utility also allows the members to choose to be reminded about their Study Plans via modes of communication including but not limited to e-mail, SMS/MMS (Short Message Service/Multimedia Messaging Service), Web feeds in the form of RSS (Really simple Syndication), and/or Atom.
xviii) Download Software and other files/utilities
   A logged-in member can download one or more software programs and/or other files/utilities from the said portal, for a fee or otherwise. These software programs, inter alia, may help the member to upload and download content from the said portal.
xix) Register as an institution/organization
   A person can register on the said portal on behalf of an educational institution/corporate organization including but not limited to a school, college, university, company, and the like. This will entitle a person to register other persons belonging to the educational institution/corporate organization on the said portal. The said portal further allots each such institution/organization a certain amount of space as may be determined by the terms and policies of the said portal from time to time. Thus, the persons belonging to an institution/organization can log in to the said portal and enjoy the various features and utilities available on the said portal from time to time.
xx) Convert Content in an Interoperable Format
   The said portal provides a logged-in member with a utility to convert the content present in the said portal in the form of an interoperable format including but not limited to SCORM (Sharable Content Object Reference Model). Once the content has been converted, it can be imported/deployed into one or more LMSes (Learning Management Systems) or LCMSes (Learning Content Management Systems). The said portal may charge a fee or otherwise to the logged-in member for providing this utility.
xxi) Classify Content based on Curriculum
   A logged-in member can choose to classify the content he/she has uploaded on the said portal either using Curriculum as a basis or using General Knowledge as a basis. In case, the logged-in member chooses to classify content using Curriculum as a basis, then he/she can also define additional classifications including but not limited to Country, Medium of Instruction, subject, School, College, University, Board, Name of faculty, age group, Standard, difficulty level and the like.
   Further, a logged-in member is also allowed to find content classified using Curriculum as a basis by none or one or more find conditions including but not limited to keywords separated by operators and wildcard characters.
xxii) Teach/Learn to or from other locicied-in members
   A logged-in member, if he/she so desires, can volunteer to become a ‘Teacher’, ‘Instructor’, ‘Mentor’, ‘subject Matter Expert’ and the like, for one or more members of the said portal. Conversely, a logged-in member can also choose to become a ‘Student’ to one or more such ‘Teachers’ on the said portal.
   If a logged-in member chooses to become a ‘Teacher’, then he/she can perform various tasks including but not limited to selecting one or more categories/subjects for which he/she wishes to become a ‘Teacher’, inviting other logged-in members to become his/her ‘Students’, creating, modifying, organizing, sharing content for his/her ‘Students’ by using the relevant features available on the said portal, ‘tutoring/mentoring’ other logged-in members by using one or more of the means of communication available on the said portal, creating tests, quizzes, assessments. and/or assignments for his/her ‘Students’, and further monitoring their progress.
   If a logged-in member chooses to become a ‘Student’, then he/she can perform various tasks including but not limited to selecting categories/subjects for which he/she wishes to avail the services of a ‘Teacher’, selecting one or more ‘Teachers’ available for a particular category/subject, inviting other logged-in members to avail the services of the ‘Teachers’ selected by him/her, creating, modifying, organizing, sharing content with other ‘Students’ by using the relevant features available on the said portal, interacting with the ‘Teachers’ by using one or more of the means of communication available on the said portal, and taking tests, quizzes, Assessments. and/or Assignments that may have been set by one or more ‘Teachers’.
xxiii) View Statistics
   A logged-in member can choose to view various kinds of statistics on the said portal, including but not limited to the number of members who have visited his/her Profile Page, the number of members who are currently online, the number of categories available and so on.
xxiv) Help
   A logged-in member can choose to access the relevant help section on the said portal, in order to know more about the features and/or utilities available on the said portal.

### 3. Administration Module

The said portal comprises of an Administration Module which allows the administrator of the said portal, inter alia, to monitor the activity of the members as well as the content uploaded and/or downloaded to or from the said portal from time to time.

The administrator can choose to monitor the content either automatically or manually. For monitoring content manually, the administrator specifies a list of keywords whose use is restricted and/or banned, in the Administration Module. The administrator then initiates the process of searching these keywords in the content that has been uploaded and/or modified on the said portal. This process can be initialized at time intervals set by the administrator. If one or banned and/or restricted keywords are found in the content, the same are removed from the said portal and sent to the administrator for final review. The administrator may choose to either approve or reject such content. This entire process can also be automated by the administrator, where the restricted and/or banned content is removed from the said portal automatically, based on the said keywords, and no manual intervention is required from the administrator.

Further, the administrator of the said portal can perform various administrative tasks including but not limited to allotting space to members, groups, managing the number of members and/or groups, giving certain rights/privileges to members, add or delete members/groups, set a limit to which content can be uploaded and/or downloaded at a time, create new categories/classifications as per the requests by the members, administer the advertisements appearing on the said portal, and so on.

### 4. Community Portal Toolbar

The said portal further allows a member to download a toolbar program on his/her computer system and/or handheld device. The member may use this program to access one or more of the features that may be available on the said portal, instead of having to log on to the said portal. For example, the program may be customized to perform various tasks including but not limited to getting alerts from the said portal about any newly uploaded content, news, and upcoming events, uploading and/or downloading content to and from the said portal and the like, searching for content on the said portal, and the like.

### 5. Rewards

The said portal further offers members with rewards including but not limited to points, goodies, and so on, depending on various parameters like the quality, popularity, and the usefulness of the content uploaded by them on the said portal. These rewards are subject to the terms and policies of the said portal.

### TECHNICAL APPLICATION TO THE INDUSTRY

The invention has the potential to create large worldwide communities of people interested in sharing educational and/or entertainment resources in a well-organized manner. People can share such resources in universally accepted formats including but not limited to that of database files, XML (eXtensible Markup Language) and so on. This would immensely benefit all those who are keen on increasing and/or improving their knowledge on one or more topics of their choice. Following are some of the technical applications of the invention for the education and the entertainment industries:
i) Communities for education and other purposes
   The present invention can be used to create one or more communities of people who share the same interests. For example, in a school, teachers and students can form their own community wherein the teacher can interact with the students with respect to their day-to-day studies, share educational resources with them, take periodic tests/quizzes/Assessments, assign homework/assignments and do much more. Similarly, in a corporate organization, the members/employees or other staff can form their community to share their knowledge and expertise, voice their opinions, give information about the upcoming events and so on.
ii) Content Providers
   The invention could be used by professional Content Providers as a global platform to create, sell, and/or distribute their content to a large target audience.
iii) Publishing/Printing
   The invention can be used by publishers for the regular publishing of encyclopedias, fact books, quiz books, novels, and much more. Moreover, since the invention allows a detailed classification of information, subject-specific publications can be made with ease.
iv) E-commerce
   The invention can be used by third-party suppliers/vendors/resellers of goods and services, as an online platform to sell and/or market their wares.
v) Mobile Services
   The invention facilitates creation and sharing of content in a diverse form such as questions and answers, resources for language learning (using vocabulary as a basis), proverbs, Quotes, sayings, facts and feats, literary works, jokes and/or other forms of humor, lyrics of musical compositions and such others which can be offered as part of Value Added Services by mobile service operators. The popularity of SMS/MMS/WAP would ensure a large audience for such kind of content, thus adding another dimension to these services.
vi) Television & Radio
   The invention can be used to provide a repository of content for use by Radio and Television programmes belonging to various genres like quiz shows, game shows, comedy shows, musical shows, dramas, and many more.

I claim:

1. An interactive community portal comprising of one or more communities, which, inter alia, allows its members to create, modify, organize, share, and receive well-classified content of a diverse nature, in any language, on one or more computer systems, hand held devices, websites, networks, blogs/forums, intranets, and such present or future technologies that are available, or may be available at any time in the future, which facilitate communication including but not limited to sharing, and comprising of:
i) a user interface;
ii) a well-classified database comprising:
a. a content database which is a reservoir of well-classified data in the form of questions and answers (on any subject) duly classified by various classifications like source of information, age group, difficulty level, subject and sub subjects, and which may be in one or more formats like question answer, multiple choice, true or false, fill in the blanks, match maker, and frame a question, resources for language learning (using vocabulary as a basis) duly classified by various classifications like source of information, type, variant, age group, difficulty level, subject, part of speech, and occurrence; documents, presentations, spreadsheets, or any other file types, URLs (uniform resource locators), duly classified by various classifications like index letter, source of information, type/category, file type, subject and sub subjects; literary works duly classified by various classifications like source of information, language, age group, type, genre, sub genre, and author/poet; proverbs, sayings, facts and feats duly classified by various classifications like source of information, type, subject and sub subjects; jokes and/or other forms of humor duly classified by various classifications like source of information, age group, joke type, subject and sub subjects; musical compositions, their text, lyrics and other related information duly classified by various classifications like artist/band, source of information, genre, syllable, film/album, language, and sub-genre; pictures (such as photographs, drawings, art, sketch, iconography, illustrations, portraits, paintings, images and such others), videos, duly classified by various classifications like creator, source, category, and sub category.
b. a translation database which is a reservoir of translated data;
c. a user database which is a reservoir of user information and also contains the history of past user interaction with the system.
d. a configuration database which is the reservoir of the options used for the customization of the system.
iii. a control system acting as a bridge between the user interface and the databases.

2. The community portal according to claim 1, wherein the said portal further provides a means to allow members to create and/or join one or more communities, networks, blogs, forums, discussion boards, inter alia, of members, in one or more sections of the said portal, which may be based on common factors including but not limited to interests, hobbies, favorites and such others.

3. The community portal according to claim 1, wherein the said portal further provides a means to allow members to upload content, in a format including but not limited to that of a database file, or by adding the content on the said portal, leading to appending the relevant databases on the said portal, using a computer or handheld device.

4. The community portal according to claim 1, wherein the said portal further provides a means to allow members to receive content from other members who may have uploaded the content in a manner that the file (being downloaded) containing the content, being a database file, appends the relevant databases of the importing member's computer or handheld device.

5. The community portal according to claim 3, wherein the said portal further provides a means to allow members to receive content from other members who may have uploaded the content in a manner that the file (being downloaded) containing the content, being a database file, appends the relevant databases of the importing member's computer or handheld device.

6. The community portal according to claim 1, wherein the said portal further provides a means to allot each member a certain amount of space as may be determined by the terms and policies of the community portal, where the member can use this space for various tasks including but not limited to uploading and/or downloading content to or from the community portal.

7. The community portal according to claim 1, wherein the said portal further provides a means to allow members to enhance the content uploaded by other members, by adding more information inter alia, in the form of remarks, and/or associating/attaching files or URLs (Uniform Resource Locators).

8. The community portal according to claim 3, wherein the said portal further provides a means to allow members to enhance the content uploaded by other members, by adding more information inter alia, in the form of remarks, and/or associating/attaching files or URLs (Uniform Resource Locators).

9. The community portal according to claim 1, wherein the said portal further provides members with one or more software programs for a fee or otherwise, which allow a member to receive content from the community portal, inter alia, in the form of one or more database files, as well as create, organize, and upload content to the community portal, inter alia, in the form of one or more database files.

10. The community portal according to claim 1, wherein the said portal further provides a means to allow members to decide whether or not the content that may have been uploaded by them, inter alia, should be accessed only by themselves, or the members who are part of their group and/or network, or all the members of the said portal.

11. The community portal according to claim 1, wherein the said portal further provides a means to allow members to rate the content on the community portal, which may have been uploaded by other members on the said portal.

12. The community portal according to claim 1, wherein the said portal further provides a means to allow members to create one or more new set of classifications and/or categories on the said portal, which can be used by other members, inter alia, to classify the content that they upload on the said portal.

13. The community portal according to claim 1, wherein the said portal further offers members with rewards including but not limited to points, goodies and so on, for the content uploaded by them, based on various parameters like the quality, popularity, and usefulness of the said content, subject to the policies of the said portal.

14. The community portal according to claim 1, wherein the said portal further provides a means to allow members to offer one or more products and/or services for sale on the said portal, and further a means to share with the members the revenue generated through advertising on the said portal, subject to the policies of the said portal.

15. The community portal according to claim 1, wherein the said portal further provides a means to allow members to find content by none or one or more find conditions including but not limited to keywords separated by one or more operators and wildcard characters, the relevant classifications pertaining to the said content, as well as by file attachments, attachment remarks, association remarks, import remarks, or bookmark remarks including, but not limited to, whether or not the content is marked so as to be accessed only by the members themselves, or by members who are part of the current members' group and/or network, or by all the members of the said portal, as well as “favorite”, and further exercise the option of using the said find conditions to bring forth or avoid content.

16. The community portal according to claim 1, wherein the said portal further provides a means to offer members, with respect to content like questions and answers and resources for language learning (using vocabulary as a basis), the utility to:
i) take practice sessions,
ii) create and/or take tests, quizzes, or assessments in one or more questioning formats including but not limited to question answer, multiple choice, true or false, fill in the blanks, match maker, frame a question, acrossword, figure out, fill in the blanks, hangman, match maker, memory challenge, spelling challenge, word cousins, and word juggler, tests, quizzes, or assessments based on rules of grammar including but not limited to count, degrees of comparison, gender, tense, voice, and parts of speech, either online or in the form of file formats including but not limited to HTML (Hypertext Markup Language), XML (eXtensible Markup Language), and WML (Wireless Markup Language).
iii) obtain a performance report of the tests, quizzes, or assessments.
iv) create study aids like flash cards, snap cards, snap cards reference sheet, as well as question list/vocabulary list.

17. The community portal according to claim 1, wherein the said portal further provides a means to allow members to choose to classify the relevant content on the community portal using curriculum as a basis by defining additional classifications including but not limited to country, medium of instruction, subject, school, college, university, board, name of faculty, age group, standard, difficulty level and such others.

18. The community portal according to claim 1, wherein the said portal further provides a means to offer, with respect to content like jokes and humor the utility to members to enjoy the jokes and humor as a laughter session, where jokes and humor are displayed to the member one after the other in a random and/or pre-determined order.

19. The community portal according to claim 1 wherein the said portal further provides a means to offer, with respect to content like songs and lyrics, the utility to members to enjoy the songs and lyrics as a music session, where the songs and lyrics are displayed to the member one after the other in a random and/or pre-determined order.

20. The community portal according to claim 1, wherein the said portal further provides a means to offer members to play a game of ‘antakshari’ with one or more members or groups of members on the community portal, by joining one or more ‘antakshari zones’ on the said portal.

21. The community portal according to claim 1, wherein the said portal further provides a means to offer, with respect to content like proverbs, sayings, facts and feats, the utility to members to enjoy the proverbs, sayings, facts and feats as a wisdom session, where the said proverbs, sayings, facts and feats, are displayed to the member one after the other in a random and/or pre-determined order.

22. The community portal according to claim 1, wherein the said portal further provides members with the utility of a study planner which will allow them to plan their studies in an organised manner, by displaying the appropriate reminders at regular time intervals on their computer and/or hand held device.

23. The community portal according to claim 1, wherein the said portal further provides the administrator of the said portal, the means to monitor the content uploaded and/or downloaded to and from the said portal, either manually or automatically.

24. The community portal according to claim 1, wherein the said portal further provides a means to allow members to keep notes about their day-to-day tasks and/or activities, as well as choose to be reminded about the same via modes of communication including but not limited to e-mail, SMS/MMS (Short Message Service/Multimedia Messaging Service), web feeds such as RSS (Really simple Syndication), and/or Atom.

25. The community portal according to claim 1, wherein the said portal further provides a means to allow members to access the same through a WAP (Wireless Application Protocol) enabled mobile device and such present or future technologies that are available, or may be available at any time in the future.
